(19) United States
(12) Patent Application Publication
(10) Pub. No.: US 2018/0123108 A1
(43) Pub. Date: May 3, 2018

(54) CELL FRAME FOR ACCOMMODATING POUCH CELLS

(71) Applicant: Robert Bosch GmbH, Stuttgart (DE)

(72) Inventors: Josef Ranner, Bad Aibling (DE); Maximilian Oscar Bader, Muenchen (DE); Michael Moser, Bruckmuehl (DE)

(21) Appl. No.: 15/800,812

(22) Filed: Nov. 1, 2017

(30) Foreign Application Priority Data
Nov. 2, 2016 (DE) 10 2016 221 492.6

(51) Int. Cl. H01M 2/20; H01M 2/10; H01M 10/0525; H01M 10/48

(52) U.S. Cl. CPC H01M 2/206; H01M 2/1077; H01M 2220/20; H01M 10/482; H01M 10/486; H01M 10/0525

(57) ABSTRACT

A cell frame (8) for accommodating a specific number of pouch cells (14), having an integrated cell collector (10), wherein the cell connector (10) provides contact pads for clinching. A battery pack and a method for producing a battery pack are also specified.

### BACKGROUND OF THE INVENTION

The invention relates to a cell frame for accommodating a specific number of pouch cells. A battery pack and a method for producing a battery pack are also specified.

Battery packs and battery modules for lithium ion pouch cells with different voltage ranges are known. In addition to a highest possible power to weight ratio, in practice strict requirements are placed on the reliability of such energy stores. The production and material costs in electrical energy stores likewise represent a challenge. Therefore, in most systems which are currently used in electric and hybrid vehicles, round cells are still used. As a result, although the requirements on energy content and costs are achieved, a lower power density has to be accepted for this purpose.

US 2011/0210954 A1 discloses accommodating battery cells of the “jelly roll” type firstly in a metal pouch and then in a cell frame. The cell frame has a compartment for a rail, in which cell connectors for making contact with the jelly roll are produced.

In order to obtain higher power densities and also greater variance in structural forms, the use of pouch cells for energy stores in the automobile is expedient.

US 2014/0356672 A1 discloses a battery pack comprising a frame element for positioning and mechanically fixing a specific number of pouch cells. The disadvantage with this solution is that additional components are needed to make electrical contact with the battery cells.

### SUMMARY OF THE INVENTION

It is an object of the invention to provide the mechanical incorporation of pouch cells in a battery pack and at the same time to produce an electric contact between the pouch cells in a simplified manner.

In a cell frame according to the invention for accommodating a specific number of pouch cells, an integrated cell connector is provided, wherein the cell connector provides contact pads for clinching.

“Integrated cell connector” means that the cell frame is provided as a component or a semifinished product in which the cell connector is fixedly incorporated. For example, provision can be made through the cell connector to be held firmly by the cell frame in a force-fitting, form-fitting and/or integral manner, for example bonded on, clamped in and/or potted.

Advantageously, the cell frame is embodied in one piece with the cell connector, so that, in the solution proposed, the number of individual parts is reduced as compared with the known solutions.

Using pouch cells, battery cells with foil sleeves produced from a soft material are designated for the electrochemically active material. The pouch cells have current collectors which make electrical contact with the electrochemically active material in the interior of the sleeve and are led out of the cell as small tabs. Within the context of the present disclosure, these small tabs are also designated as cell contacts. The cell contacts are used for wiring the pouch cells with further pouch cells in parallel and series circuitry to form battery strings and battery modules.

The pouch cell can both be a primary battery cell and a secondary battery cell which is configured to store electrical energy and to convert chemical reaction energy into electrical energy and vice versa. Secondary battery cells are also designated as accumulator cells. In particular, the pouch cell can be a so-called lithium ion cell, which is typically distinguished by particularly high energy density, thermal stability and low self-discharge.

The electrochemically active material is located within the foil sleeve and is assigned two electrodes, namely a positive electrode, which is also designated as a cathode, and a negative electrode, which is also designated as an anode. During the electrochemical reaction of the discharging process, electrons flow in an outer circuit from the anode to the cathode. Within the battery cell, the lithium ions migrate from the anode to the cathode. During the charging operation, on the other hand, the lithium ions migrate from the cathode to the anode.

The electrodes of the battery cell can, for example, be formed in the manner of foils and, with the interposition of a separator, can be surrounded by a liquid electrolyte. The electrolyte is conductive to the lithium ions and permits the transport of the lithium ions between the two electrodes.

The electrochemically active material of the cathode can be, for example, a metal oxide. The electrochemically active material of the anode can be, for example, graphite or silicon.

The foil sleeve is made of a soft and/or flexible material. For example, an aluminum-plastic composite film is suitable as material for the foil sleeve. This can be made, for example, from an aluminum layer with a thickness of 10 to 100 μm, preferably of 30 to 80 μm, and one or more plastic layers, for example of polypropylene. The plastic layer permits here the integral connection of multiple foil elements by thermal methods such as hot sealing, for example. The thickness of the foil sleeve is from 50 to 500 μm, preferably from 100 to 300 μm. The advantages of the foil sleeve lie in the ability to be formed as desired, the low complexity of the joining and closing process, for example by hot sealing, and in the thin configuration of the cell housing.

Although the foil sleeve is made of a soft and/or flexible material, it can be substantially present in a prismatic form, i.e. in that it has six sides, wherein typically two of the six sides form main surfaces and four of the six sides form secondary surfaces. Here, “substantially” means that the corners and edges can be rounded. The main sides are the larger sides in terms of area than secondary sides.

In preferred embodiments, the cell connectors can be used for voltage and temperature monitoring.

The cell frame is preferably made of a material that can be injection molded, for example of a plastic such as PET (polyethylene terephthalate), PE (polyethylene), thermoplastic such as PA6 (polyamide 6), PA6/6T (polyamide 6/6T), PPA (polyphthalamide), PBT (polybutylene terephthalate) or PPS (polyphenyl sulfide), wherein the plastics can be present in pure processed form or with fillers, for example for mechanical reinforcement.

The cell frames preferably have at least one support shoulder which is dimensioned to support a pouch cell. The pouch cells can be supported, for example, on two opposite sides of the pouch cell or peripherally.

Preferably, the cell frame has at least one web, in which the cell connector is accommodated. More preferably, the cell frame has at least one web, in which the cell connector is embedded. Here, “embedding” means that the cell connector is at least partly enclosed by the material of the web in such a way that it is held firmly therein.

The location of the web with the accommodated cell connectors is also designated as the front side of the cell frame within the context of the present disclosure.

According to a preferred embodiment, the cell frame has a central window approximately of the size of a pouch cell. Here, the cell frame in the region of the central window forms a cut-out, in which at least one pouch cell can be accommodated.

The cell frame is preferably designed to accommodate an even number of pouch cells, in particular for example to accommodate four pouch cells. For instance, provision can be made for two pouch cells to be arranged resting on each other in the region of a central window. Provision can also be made for cooling plates or spacing elements to be present between two pouch cells arranged resting on each other.

A battery pack according to the invention comprises a framework and pouch cells accommodated therein, wherein the framework comprises at least one of the cell frames described. The area of use for the battery pack can be motor vehicles, in particular electric vehicles, hybrid vehicles and plug-in hybrid vehicles.

The pouch cells are preferably present in two different variants, wherein this can relate to the type, shape and position of the cell contacts. Each pouch cell can in particular be formed in such a way that it has a main surface from which the cell contacts protrude. The cell contacts here lie in the plane of the main surface. This side of the pouch cell is designated the underside of the pouch cell within the context of the present disclosure. Since, typically, two cell contacts protrude from the pouch cell, the polarization can in principle be carried out in two different ways, wherein positive pole and negative pole are interchanged in the two ways. The pouch cell can, for example, have a flat cell contact and an angled cell contact, for example a positive pole with a flat cell contact and a negative pole with an angled cell contact or vice versa.

According to a preferred embodiment, the pouch cells are present in such a battery pack in exactly two mutually mirror-symmetrical variants. In this way, a particularly space-saving solution is provided.

According to a further preferred embodiment, provision is made for pouch cells accommodated in a framework to be wired in series with one another. The pouch cells can form a battery string which represents an independently connectable unit of the battery pack.

A method according to the invention for producing a battery pack comprises the following steps:
providing at least one cell frame for accommodating a specific number of pouch cells, having an integrated cell connector, wherein the cell connector provides contact pads for clinching,
arranging a specific number of pouch cells with the cell frame,
clinching at least one current collector of at least one pouch cell with a contact pad of an integrated cell collector of the cell frame.

During the clinching, also designated under the protected trade name Tox clinching, a joining pressing process from manufacturing technology according to DIN 8593 in the version valid on 19 Aug. 2016 is designated. In the present method, both the cell connector and the cell contacts can be connected to each other by means of clinching, and cell contacts can also be connected to one another. Clinching is described, for example, on the Internet page www.tox-de.com/verfahren/clinchen/tox-verbindungstechnologie retrieved on 19 Aug. 2016.

Provision is preferably made that, in the case in which multiple cells are used in the battery pack, in each case two pouch cells are arranged resting on one another indirectly or directly back-to-back between two cell frames, wherein their current collectors make direct contact with each other.

The battery pack preferably additionally comprises a start frame, which likewise has preferably integrated cell connectors which have contact pads for clinching. Contact is likewise made with the pouch cells which are arranged in the start frame preferably by means of clinching.

The battery pack also preferably comprises an end frame, which is designed to accommodate pouch cells. The end frame preferably has a cut-out and/or an integrated metal element in order to provide connections of the battery pack to the outside.

In order to make electrical contact, the current collectors of the pouch cells are connected to one another. Contact is made between each of the pouch cells which are not located in the bottom element or in the top element and a further pouch cell via a contact pad of the cell frame.

With the provision according to the invention of the cell frame with integrated cell connector, the number of individual parts for producing the battery pack is reduced. Additional advantages result from the freedom in the isolation of the cell connectors and from possible good accessibility of the contact pads for the tools of the production technology.

### BRIEF DESCRIPTION OF THE DRAWINGS

The invention will be illustrated in more detail below by using the drawings, wherein these are merely to be understood as illustrative and do not restrict the invention.

FIG. 1 shows an isometric view of a framework according to an embodiment of the invention,

FIG. 2 shows an overturned isometric view of a framework according to a further embodiment of the invention,

FIG. 3 shows a front view of the framework from FIG. 1 with an illustration of a current path,

FIG. 4 shows a sectional view along the line C-C of the framework from FIG. 3,

FIG. 5 shows an isometric view of a cell frame according to an embodiment of the invention,

FIG. 6 shows a front view of the cell frame from FIG. 5,

FIG. 7 shows a sectional view along the line A-A of the cell frame from FIG. 6,

FIG. 8 shows an isometric view of a start frame according to an embodiment of the invention,

FIG. 9 shows a front view of the start frame from FIG. 8, and

FIG. 10 shows a sectional view along the line B-B of the start frame from FIG. 9.

In the figures, similar or identical features are represented by similar or identical designations. In individual cases, a repeated description is omitted.

### DETAILED DESCRIPTION

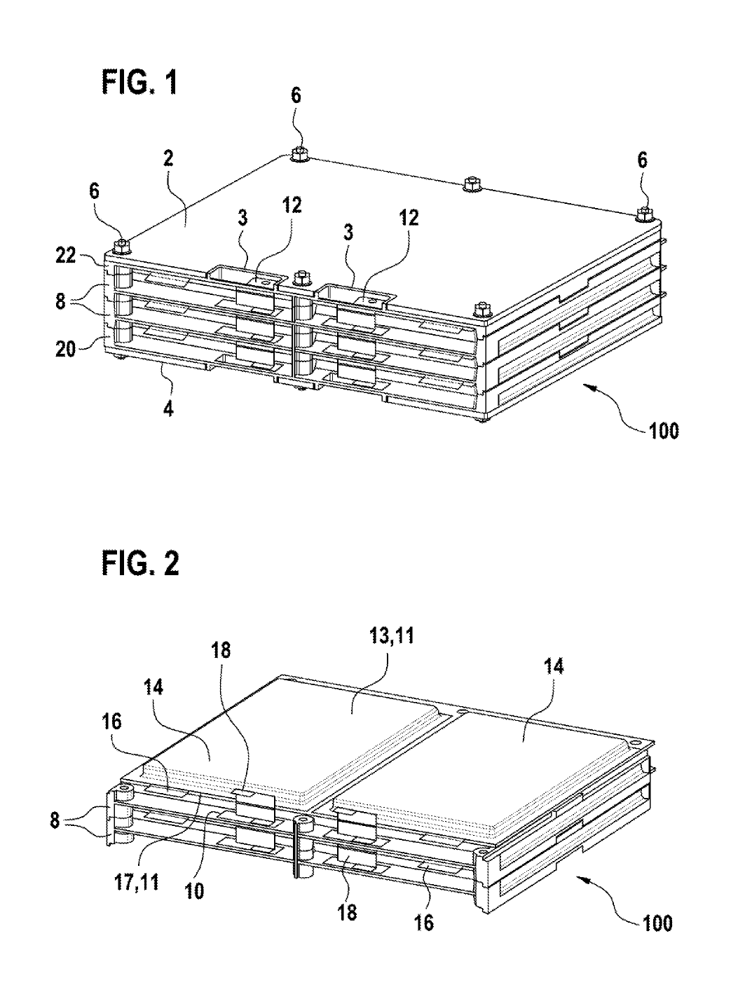

FIG. 1 shows a perspective view of a framework 100 according to an embodiment of the invention. The framework 100 can form part of a battery pack.

The framework 100 comprises an arrangement having a top plate 2, an end frame 22, two cell frames 8, a start frame 20 and a bottom plate 4 which, in the exemplary embodiment illustrated, are held firmly together in this order by six clamping screws 6. In the exemplary embodiment illustrated, twelve pouch cells 14, which are not visible in this perspective view, are accommodated in the framework 100.

The top plate 2 has two cut-outs 3 on the front in order to provide connections 12 for making external contact with the pouch cells 14.

FIG. 2 shows an inverted view of a framework 100 which comprises two cell frames 8 arranged above each other, and eight pouch cells 14 held in the framework 100. The cell frames 8 illustrated are each populated with four pouch cells 14 and constitute part of the framework 100.

Each pouch cell 14 comprises two main sides 11, wherein one of the main sides 11 forms an upper side 13 and a further main side 11 forms an underside 17 of the pouch cell 14. The pouch cells 14 have cell contacts 16, 18, wherein the cell contacts 16, 18 protrude from the underside 17 of the pouch cell 14. The cell contacts 16, 18 are formed differently, wherein each pouch cell 14 has a straight cell contact 16 and an angled cell contact 18, which form a positive and a negative pole. In the interior of the pouch cell 14, the cell contacts 16, 18 make contact with the electrochemically active material of the respective electrodes.

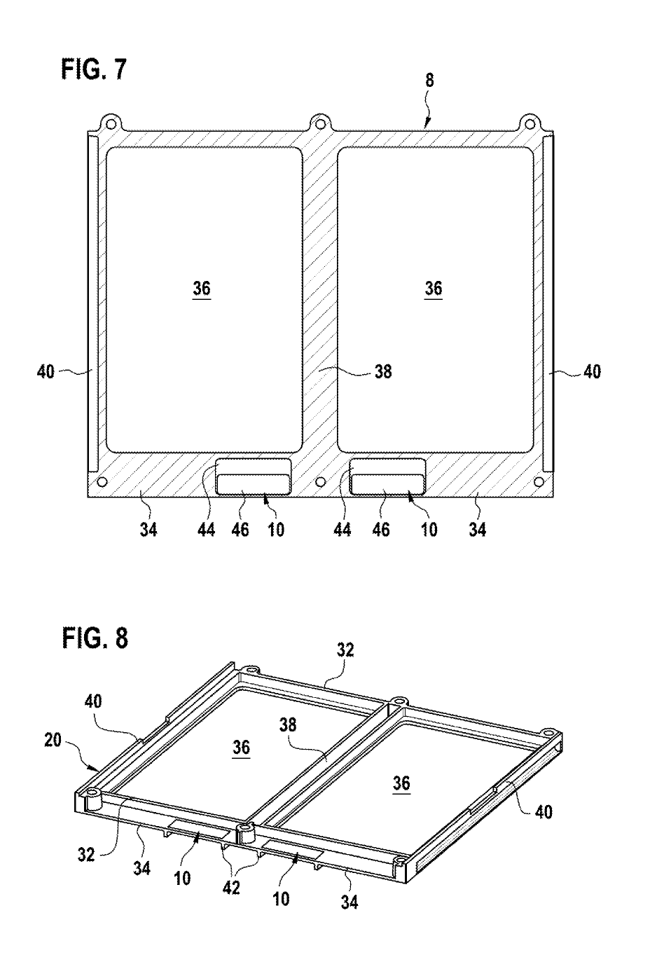

The cell frames 8 have integrated cell connectors 10, which are described in more detail in particular with reference to FIGS. 7 and 10. In four of the pouch cells 14 illustrated, the angled cell contact 18 is led to a cell connector 10 integrated into the cell frame 8 and makes contact therewith. The straight cell contact 16 is connected to the next pouch cell 14 resting back-to-back.

As can be seen from FIG. 2, there are two different types of pouch cells 14, namely those in which the angled cell contact 18 looks out on the left on the front side 7 and those in which the angled cell contact 18 looks out on the right on the front side 7. The polarization of the cell contacts 16, 18 is implemented mirror-symmetrically, so that overall two different types of pouch cells 14 are present.

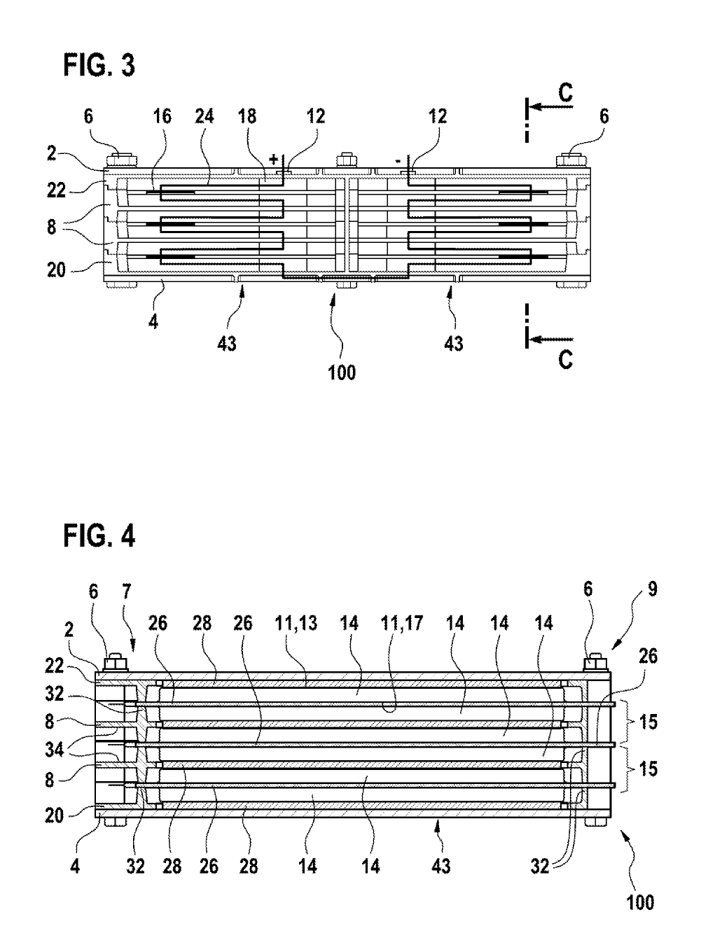

In FIG. 3, a front view of the framework 100 described with reference to FIG. 1 is illustrated.

Also illustrated in FIG. 3 is a current path 24, which illustrates a series circuit of the pouch cells 14. Plus and minus are present on the connections 12. Here, by way of example, the current from the positive pole goes firstly through an angled cell contact 18 into the interior of a first pouch cell 14, from there via a straight cell contact 16, which makes direct contact with a further straight cell contact 16 of the adjacent pouch cell 14, into the adjacent pouch cell 14. If, therefore, for example plus is present on the straight cell contact 16 of the first pouch cell 14, then a negative potential in relation to the series circuit is present on the straight cell contact 16, which is therefore contacted directly, of the adjacent pouch cell 14.

The current path 24 leaves a left-hand stack 43 of pouch cells 14 via the start frame 20 and is led to a right-hand stack 43, where it leads through pouch cells 14 arranged mirror-symmetrically with respect to the first stack 43 to the second connection 12.

FIG. 4 shows a side view through the framework 100 according to FIG. 3, wherein the view represents the section through C-C from FIG. 3.

In FIG. 4, the total of six pouch cells 14 which form the second stack 43 can be seen clearly. An arrangement with a cell frame 8 according to the invention and the pouch cells 14 held therein is also designated as a cell pack 15. The exemplary embodiment illustrated comprises two cell packs 15.

Between the cell packs 15 there are cooling plates 26, which make contact with the pouch cells 14 over a large area in order to provide efficient cooling.

Within each cell pack 15, the two pouch cells 14 with their upper sides 13 butting up against each other are spaced apart from each other by spacers 28.

As can be seen in this sectional view, a front side 7 and a rear side 9 of the start frame 20, end frame 22 and cell frames 8 are not formed identically. On the front side 7, there is in each case a web 34, in which the cell connectors 10 are integrated. The web 34 is not provided on the rear side 9 of these components.

In the sectional view illustrated, the cell frame 8 therefore has a cross-shaped profile on its front side 7, whereas it has a T profile on its rear side 9.

In the sectional view illustrated, the start frame 20 and the end frame 22 have a T profile on their front side 7 and an L profile on their rear side 9.

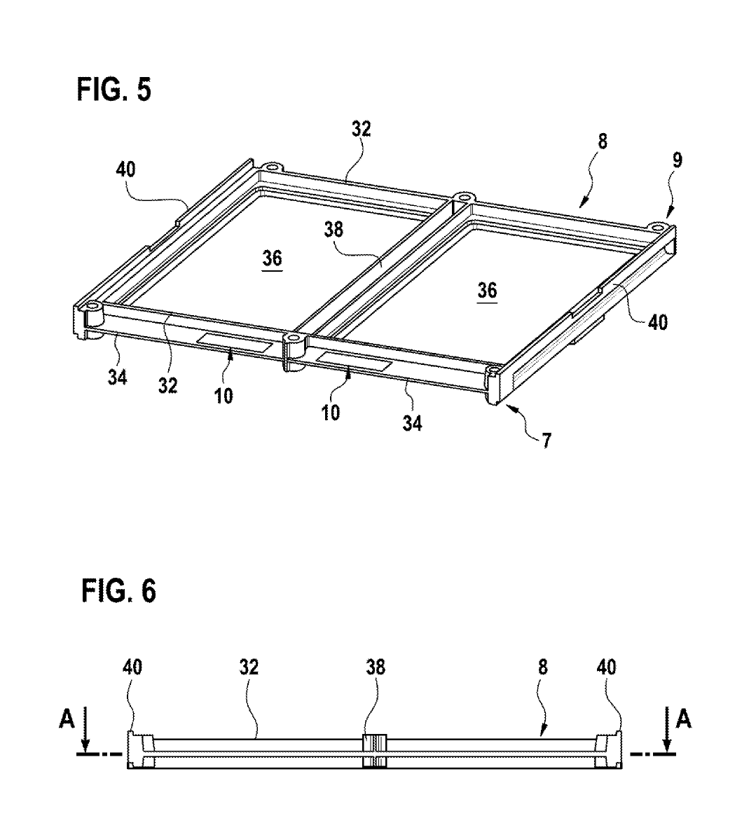

FIG. 5 shows a perspective view of the cell frame 8 according to one embodiment of the invention. The cell frame 8 has two central windows 36 arranged beside each other, which in their dimensions correspond approximately to the size of the pouch cells 14, so that the cavities defined by the central windows 36 are designed to accommodate the pouch cells 14.

The central windows 36 are separated from each other by a central web 38.

The cell frame 8 has a support shoulder 32 which, in the exemplary embodiment illustrated, is formed peripherally around the central window 36. In addition, lateral terminating walls 40 are provided at the sides.

The cell connectors 10 are integrated in the cell frames 8 and are located on a web 34 on the front side 7 of the cell frame 8.

FIG. 6 shows a sectional view through the cell frame 8 from FIG. 5.

As can be seen, the lateral terminating wall 40 is designed to be somewhat higher than the support shoulder 32. The same is true of the central web 38. The space produced as a result is occupied by the cooling plate 26.

FIG. 7 shows a plan view of the cell frame 8 which has been described with reference to FIGS. 5 and 6. The cell collector 10 is integrated in the web 34 of the cell frame 8. During production, an injection molding method is used, wherein the cell connector 10 is laid in the mold of the cell frame 8. In the embodiment illustrated, the cell connector 10 is embedded in the cell frame 8, wherein it has a region 44 which is surrounded completely by the plastic of the cell frame 8, and an open region 46, in which contact can be made with the cell contacts 16, 18.

FIG. 8 shows a perspective view of a start frame 20 according to an embodiment of the invention. The cell frame 20 is formed substantially like the cell frame 8 as described with reference to FIGS. 5-7 but differs from the latter in particular in the implementation of the cell connectors 10 and in the fact that it is designed to accommodate only half as many pouch cells 14, i.e. two here, since no pouch cells 14 can be accommodated underneath the start frame 20. The start frame 20 additionally has feet 42, which are provided for stability.

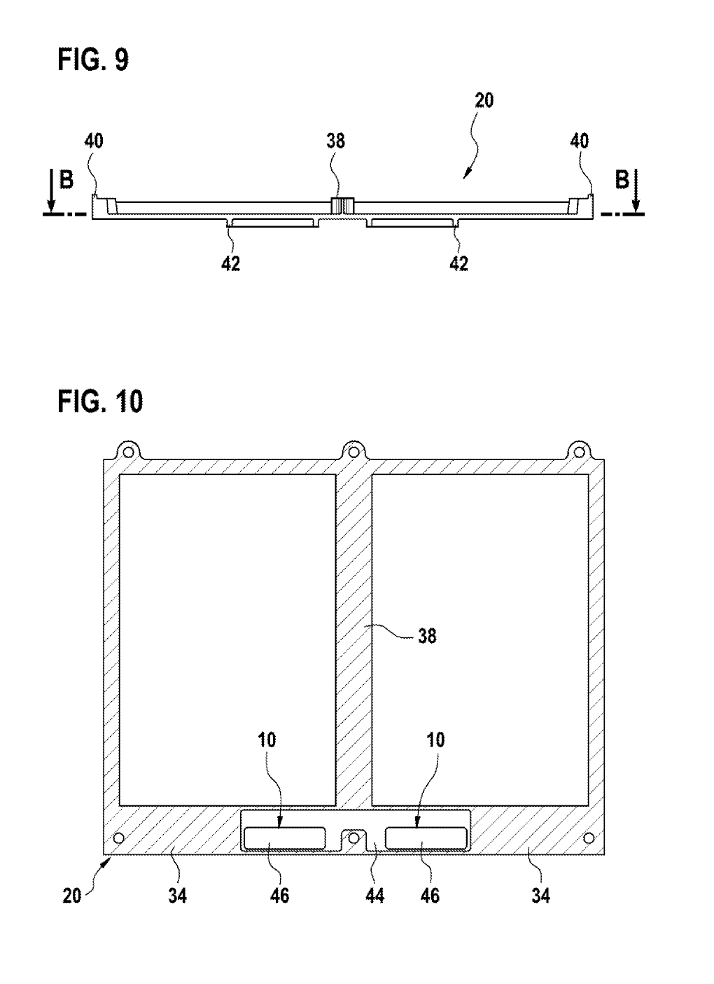

FIG. 9 shows a front view of the start frame 20, wherein it is shown that this differs from the cell frame 8, in particular in height.

FIG. 10 shows the start frame 20 in plan view. The cell connector 10 of the start frame 20 is once more embedded in the plastic of the start frame body, so that it has open regions 46 and hidden regions 44. However, the cell connector 10 is formed in one piece here, so that a through-contact from the left-hand cell connector 10 to the right-hand cell connector 10 is provided here.

The invention is not restricted to the exemplary embodiments described here and the aspects emphasized therein. Instead, within the area specified by the claims, a large number of modifications which lie within the scope of professional activity are possible.

1. A cell frame (8) for accommodating a specific number of pouch cells (14), the cell frame comprising an integrated cell connector (10), wherein the cell connector (10) provides contact pads for clinching.

2. The cell frame (8) according to claim 1, characterized in that the cell frame (8) has a support shoulder (32) which is dimensioned to support a pouch cell (14).

3. The cell frame (8) according to claim 1, characterized in that the cell frame (8) has a web (34), in which the cell connector (10) is accommodated.

4. The cell frame (8) according to claim 1, characterized in that the cell frame (8) has a central window (36) approximately of the size of a pouch cell (14).

5. The cell frame (8) according to claim 1, characterized in that the cell frame (8) is designed to accommodate an even number of pouch cells (14).

6. A battery pack having a framework (100) and pouch cells (14) accommodated therein, wherein the framework (100) comprises at least one cell frame (8) according to claim 1.

7. The battery pack according to claim 6, characterized in that the pouch cells (14) are present in two mutually mirror-symmetrical variants.

8. The battery pack according to claim 6, characterized in that the pouch cells (14) accommodated in the framework (100) are wired in series with one another.

9. A method for producing a battery pack, which comprises the following steps:
a) providing at least one cell frame (8) for accommodating a specific number of pouch cells (14), having an integrated cell connector (10), wherein the cell connector (10) provides contact pads for clinching,
b) arranging a specific number of pouch cells (14) with the cell frame (8), and
c) clinching at least one cell contact (16, 18) of at least one pouch cell (14) with a contact pad of an integrated cell connector (10) of the cell frame (8).

10. The method according to claim 9, characterized in that multiple cell frames (8) are used in the battery pack and in each case two pouch cells (14) are arranged resting on one another indirectly or directly back-to-back between two cell frames (8), and their cell contacts (16) make direct contact with each other.

11. The cell frame (8) according to claim 1, characterized in that the cell frame (8) has a web (34), in which the cell connector (10) is embedded.

12. The cell frame (8) according to claim 1, characterized in that the cell frame (8) is designed to accommodate four pouch cells (14).
